(19) United States
(12) Patent Application Publication
(10) Pub. No.: US 2024/0427945 A1
(43) Pub. Date: Dec. 26, 2024

(54) METHOD FOR PREVENTING CAPTURE OF INPUT FROM KEYBOARD AND DISPLAY USING KEYLOGGERS AND SCREENGRABBERS

(71) Applicant: NVIDIA Corporation, Santa Clara, CA (US)

(72) Inventors: Thorsten Peter Stremlau, Cary, NC (US); Joseph Michael Pennisi, Apex, NC (US)

(21) Appl. No.: 18/212,554

(22) Filed: Jun. 21, 2023

(51) Int. Cl. G06F 21/83; G06F 3/04842; G06F 21/84; H04L 9/32

(52) U.S. Cl. CPC G06F 21/83; G06F 3/04842; G06F 21/84; H04L 9/32

(57) ABSTRACT

A system includes a graphics card comprising a first storage area accessible by an operating system and a second storage area inaccessible by the operating system. A processing device coupled to the graphics card can cause, via one or more drivers associated with the operating system, a first screen to be presented in a graphical user interface (GUI) at a user device based on data read from the first storage area. The processing device can also cause, via one or more drivers associated with the graphics card, a second screen to be presented in the GUI based on data read from the second storage area, wherein the second screen overlays a portion of the first screen and presents one or more selectable inputs for authentication.

### TECHNICAL FIELD

At least one embodiment pertains to a use of processing resources to prevent capture of input from keyboard and display using keyloggers and screengrabbers, according to various novel techniques described herein. More specifically, at least one embodiment pertains to a use of processing resources to securely display selectable inputs that an operating system cannot access.

### BACKGROUND

A computing device (e.g., desktop computer, laptop computer, network server, mobile device, embedded computer (e.g., one included in a vehicle, industrial equipment, or a networked commercial device), or such computing device that includes a display, memory, and a processing device) can become corrupted due to malware (e.g., software designed to cause disruption to the computing device). In such examples, an operating system (OS) (e.g., a system software that manages software and hardware of the computing device) can be compromised. Sometimes, the computing device can be infected with malware (e.g., or otherwise be compromised or hacked by an unauthorized user) without knowledge of a user of the computing device—e.g., the malware can compromise the computing device without the user's knowledge. This can lead to the unauthorized user who installed the malware to be able to detect keylogging, cursor movements, or any other action taken by a user within the operating system. This can cause the user's personal information to be obtained by the unauthorized user and make entering passwords or pins on the computing device unsafe.

### BRIEF DESCRIPTION OF DRAWINGS

Various embodiments in accordance with the present disclosure will be described with reference to the drawings, in which:

FIG. 1 illustrates an example system for preventing capture of input from keyboard and display, in accordance with at least some embodiments;

FIG. 2 illustrates an example system for preventing capture of input from keyboard and display, in accordance with at least some embodiments;

FIG. 3 illustrates an example graphics card for preventing capture of input from keyboard and display, in accordance with at least some embodiments;

FIG. 4 illustrates a display for preventing capture of input from keyboard and display, in accordance with at least some embodiments;

FIG. 5 illustrates a flow diagram of an example method for preventing capture of input from keyboard and display, in accordance with at least some embodiments;

FIG. 6 illustrates a computer system, in accordance with at least some embodiments.

### DETAILED DESCRIPTION

As described above, computing devices (e.g., desktop computer, laptop computer, network server, mobile device, embedded computer (e.g., one included in a vehicle, industrial equipment, or a networked commercial device), or such computing device that includes a display, memory, and a processing device) can be affected by malware (e.g., or otherwise be compromised or hacked by an unauthorized user). This can enable an unauthorized user implementing the malware to obtain personal information of a user of the computing device. For example, the unauthorized user can access the operating system of the computing device. This enables the unauthorized user to perform keylogging (e.g., recording every keystroke made a computer user) or screen grabbing (e.g., capturing screenshots of the contents of a computer display)—e.g., the unauthorized user can see which keys are pressed on the keyboard at a given time or see what is displayed on a screen of the computing device at a given time. By performing keylogging or screen grabbing, the unauthorized user can see all or most inputs a user can select. In some examples, this can include obtaining inputs when the user enters credentials, passwords, or other personal information—e.g., the unauthorized user can determine the password based on which keys were pressed or based on characters visible on the screen of the display. For example, an unauthorized can see what characters were clicked on the screen, via either a touchscreen or a mouse click.

In some examples, the user can be entirely unaware that the computing device is compromised. Accordingly, the user can unknowingly give the unauthorized user the passwords, credentials, or personal information. This can make it difficult for the user to ever know if they are securely entering passwords, pins, or credentials that will not be compromised or otherwise stolen—e.g., some solutions do not provide a secure method for entering sensitive information.

Advantageously, aspects of the present disclosure can address the deficiencies above and other challenges by directly utilizing an internal graphics card storage area (e.g., frame buffer) to generate a secure display for entering passwords and other sensitive information. That is, the aspects of the present disclosure can bypass an operating system of a computing device (e.g., graphics drivers associated with the operating system) to securely display an area where the user can enter the password. For example, a cloud service provider (or other device or application not associated with the operating system) can request a user to be authenticated before they can access the cloud service provider. The graphics card can be configured to directly communicate with the cloud service provider to authenticate the user, without involvement from the operating system (OS). For example, the graphics card can utilize a protocol or application programming interface (API) to communicate directly with the cloud service provider—e.g., the graphics card can use a fast identity online (FIDO) protocol to authenticate requests from cloud service providers.

The graphics card can include two or more storage areas (e.g., frame buffers). A first storage area of the graphics card can store information related to a display and be associated with the operating system—e.g., the operating system can access the information stored at the first storage area and utilize graphics drivers to generate a display based on data stored at the frame buffer. A second storage area of the graphics card can store information related to a secure display that presents one or more selectable inputs for a user to securely enter passwords or other sensitive information. In some examples, the second storage area can be inaccessible by the operating system. The graphics cards can utilize one or more microcontrollers to read the second storage area and generate a display for the user when the graphics card receives an authentication request.

In one example, the graphics card can generate a secure display that overlays the display provided by the operating system, where the secure display is not accessible or visible to the operating system—e.g., the secure display is only accessible or visible to the user and not the operating system. The graphics card can generate a random (or pseudo-random) position for the secure display each time—e.g., the exact position of the display can be randomly (or pseudo-randomly) generated each time. The secure display can be a rectangle or box (e.g., a random or pseudo-random rectangle or box) that includes one or more selectable inputs—e.g., characters, alphanumeric characters, numbers, alphabetic letters, symbols, images, puzzle elements, etc. The graphics card can generate random positions for each of the selectable inputs. A user can then select the one or more selectable inputs by using their cursor (e.g., a pointer controlled by a mouse, trackpad, or other external or internal device), by using their cursor movement keys (e.g., the arrow keys on a keyboard), or via physical touch (e.g., by the user touching the screen). As the secure display is not accessible by the operating system, the secure display is also not accessible to an unauthorized user via keylogging or screen grabbing. That is, although the unauthorized user may be able to determine the keyboard was used or the cursor was moved, the unauthorized user will not be able to determine what selectable inputs were selected—e.g., due to the selectable inputs being positioned randomly, the unauthorized user cannot guess or predict how the user will move their cursor in addition to being unable to see the secure display. Accordingly, a user can securely enter their password or sensitive information, even if the operating system is corrupted.

Once the user selects the one or more selectable inputs, the graphics card can either encrypt the received inputs and output it to the cloud service provider (e.g., encrypt the received inputs so the operating system is unaware of the contents) or the graphics card can authenticate the received inputs and send an indication of the authentication to the cloud service provider. In either example the graphics card can communicate with the cloud service provider without the operating system being able to access the contents of the communications.

By using the methods described herein, a user can securely enter their passwords or sensitive information at any time—e.g., even if the operating system is corrupted. Accordingly, the user can avoid their information being obtained by an unauthorized user via keylogging or screen grabbing.

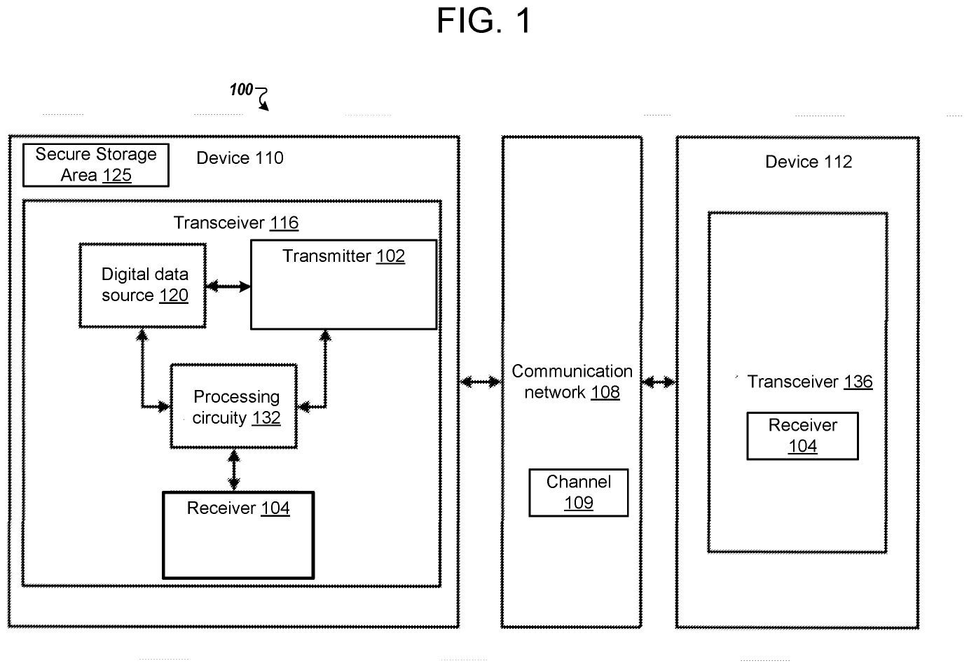

FIG. 1 illustrates an example communication system 100 according to at least one example embodiment. The system 100 includes a device 110, a communication network 108 including a communication channel 109, and a device 112. In at least one embodiment, devices 110 and 112 are two end-point devices in a computing system, such as a central processing unit (CPU) or graphics processing unit (GPU). In at least one embodiment, devices 110 and 112 are two servers. In at least one example embodiment, devices 110 and 112 correspond to one or more of a Personal Computer (PC), a laptop, a tablet, a smartphone, a server, a collection of servers, or the like. In some embodiments, the devices 110 and 112 may correspond to any appropriate type of device that communicates with other devices connected to a common type of communication network 108. According to embodiments, the receiver 104 of devices 110 or 112 may correspond to a GPU, a switch (e.g., a high-speed network switch), a network adapter, a CPU, a memory device, an input/output (I/O) device, other peripheral devices or components on a system-on-chip (SoC), or other devices and components at which a signal is received or measured, etc. As another specific but non-limiting example, the devices 110 and 112 may correspond to servers offering information resources, services, and/or applications to user devices, client devices, or other hosts in the system 100. In some embodiments, device 110 or device 112 can include a display or screen.

Examples of the communication network 108 that may be used to connect the devices 110 and 112 include an Internet Protocol (IP) network, an Ethernet network, an InfiniBand (IB) network, a Fibre Channel network, the Internet, a cellular communication network, a wireless communication network, a ground referenced signaling (GRS) link, combinations thereof (e.g., Fibre Channel over Ethernet), variants thereof, and/or the like. In one specific but non-limiting example, the communication network 108 is a network that enables data transmission between the devices 110 and 112 using data signals (e.g., digital, optical, wireless signals). In at least one embodiment, the communication network 108 can utilize a video transmission protocol—e.g., the communication network 108 can be an example of a video graphics array (VGA) or a high-definition multimedia interface (HDMI). In other examples, the communication network 108 can be an example of a different video display transmission interface coupling device 110 to device 112—e.g., displaying information stored at device 110 to a display of device 112.

The device 110 includes a transceiver 116 for sending and receiving signals, for example, data signals. The data signals may be digital or optical signals modulated with data or other suitable signals for carrying data.

The transceiver 116 may include a digital data source 120, a transmitter 124, a receiver 104, and processing circuitry 132 that controls the transceiver 116. The digital data source 120 may include suitable hardware and/or software for outputting data in a digital format (e.g., in binary code and/or thermometer code). The digital data output by the digital data source 120 may be retrieved from memory (not illustrated) or generated according to input (e.g., user input).

The transmitter 124 includes suitable software and/or hardware for receiving digital data from the digital data source 120 and outputting data signals according to the digital data for transmission over the communication network 108 to a receiver 104 of device 112. Additional details of the structure of the transmitter 124 are discussed in more detail below with reference to the figures.

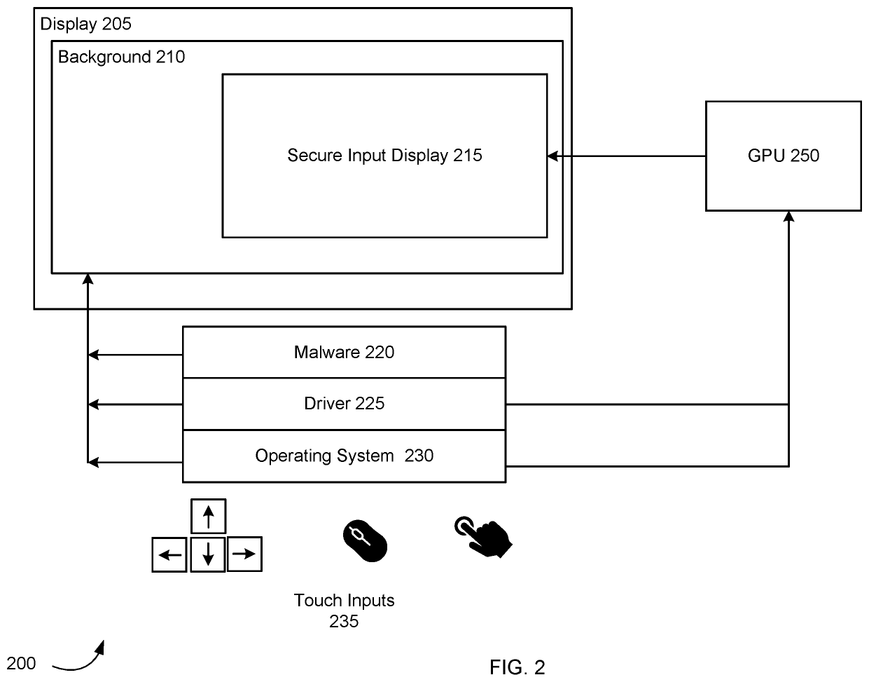

The receiver 104 of devices 110 and 112 may include suitable hardware and/or software for receiving signals, such as data signals from the communication network 108. For example, the receiver 104 may include components for receiving processing signals to extract the data for storing in a memory, as described in detail below with respect to FIG. 2-FIG. 4.

In at least one embodiment, device 110 can include a secure storage area 125. In at least one embodiment, the secure storage area 125 is inaccessible by an operating system of system 100—e.g., the data stored at secure storage area 125 may be hidden or otherwise not accessible to the operating system. In at least one embodiment, device 110 can be an example of a graphics processing unit (GPU). In such embodiments, the device 110 can access the secure storage area 125 and cause a secure input graphical user interface (GUI) to be displayed—e.g., the device 110 can access data from the secure storage area 125 and display a secure input GUI to the user that is not visible to the operating system. Accordingly, even if the operating system of system 100 is compromised or accessed by an unauthorized user, the user of the system 100 can still enter information securely. That is, the secure input GUI can bypass the operating system and be visible to the user only. Additional details regarding the secure storage area 125 and the secure input GUI is described with reference to FIGS. 2-4.

The processing circuitry 132 may comprise software, hardware, or a combination thereof. For example, the processing circuitry 132 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 132 may comprise hardware, such as an application-specific integrated circuit (ASIC). Other non-limiting examples of the processing circuitry 132 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry 132 may be provided on a Printed Circuit Board (PCB) or collection of PCBs. It should be appreciated that any appropriate type of electrical component or collection of electrical components may be suitable for inclusion in the processing circuitry 132. The processing circuitry 132 may send and/or receive signals to and/or from other elements of the transceiver 116 to control the overall operation of the transceiver 116.

The transceiver 116 or selected elements of the transceiver 116 may take the form of a pluggable card or controller for the device 110. For example, the transceiver 116 or selected elements of the transceiver 116 may be implemented on a network interface card (NIC).

The device 112 may include a transceiver 136 for sending and receiving signals, for example, data signals over a channel 109 of the communication network 108. The same or similar structure of the transceiver 116 may be applied to transceiver 136, and thus, the structure of transceiver 136 is not described separately.

Although not explicitly shown, it should be appreciated that devices 110 and 112 and the transceivers 116 and 120 may include other processing devices, storage devices, and/or communication interfaces generally associated with computing tasks, such as sending and receiving data.

FIG. 2 illustrates an example system 200 for preventing capture of input from keyboard and display using keyloggers and screengrabbers, according to at least one embodiment. System 200 can include a display 205 presenting a background 210 and a secure input display 215. In some examples, the system 200 can include an operating system 230 and driver 225 coupled to the display 205. In some embodiments, the system 200 can be compromised and include malware 220. The system 200 can further include a graphics processing unit (GPU) 250.

In one embodiment, display 205 can present still or moving images, text, or video. In at least one embodiment, the display 205 can present data for display in a graphical user interface (GUI) for a user of the display 205. In some embodiments, the display 205 can be an example of a monitor, a laptop screen, a personal computer (PC) screen, a desktop display, a television screen, or any other screen configured to present images, text, or video. In at least one embodiment, the display 205 can present data received from an operating system 230. In some embodiments, the display 205 can also present data received directly from a graphics processing unit (GPU) 250 as described herein.

In at least one embodiment, the system 200 can include an operating system 230. In some embodiments, the operating system 230 can be a system software that manages hardware and software resources of system 200—e.g., the operating system 230 can access or maintain hardware and act as an intermediary between hardware components and applications utilized by a user of system 200. For example, the operating system 230 can interrupt or receive system calls from hardware components executing an application code requested by a user of the system 200. In one embodiment, the operating system 230 can be responsible for causing a graphical user interface (GUI) to be displayed on the display 205. For example, the operating system 230 can facilitate and access data at a frame buffer of a GPU 250 to be displayed at the display 205 via driver 225. In at least one embodiment, the GPU 250 can be part of a graphics card that controls and enhances graphics (pictures, text, video, programs, animations, etc.) displayed on the display 205. In one embodiment, the driver 225 can be an example of a program that controls the graphics components within the system 200—e.g., the driver 225 can be a set of instructions that enable the system 200 to turn digital code or data into graphics, images, text, videos, etc. for display on the display 205. In one embodiment, the driver 225 can access the frame buffer of the GPU (e.g., a first storage area) in order to present the background 210 in display 205—e.g., the operating system 230 can access the first storage area and facilitate the presentation of the background 210 on the display 205. In some embodiments, the background 210 is an example of a desktop screensaver, a presentation of an application, or any other information a user requests to be presented on the display 205.

In one embodiment, system 200 can be compromised by malware 220. In one embodiment, malware 220 can be an example of a malicious software that is a file or code utilized by an unauthorized user to infect, explore, and/or steal information associated with system 200—e.g., the unauthorized user can deliver malware 220 over a network to compromise the system 200. In some embodiments, the malware 220 can cause disruption to system 200, leak private information, deprive access to an authorized user, or otherwise interfere with the security and privacy of system 200. For example, the malware 220 can utilize a screen grabber to see the information displayed on display 205—e.g., malware 220 can utilize a screen grabber to enable the unauthorized user to see a copy of the display 205. In at least one embodiment, the malware 220 can also utilize a keylogger to determine information regarding which keys a user of system 200 is utilizing. Accordingly, the malware 220 can essentially steal information regarding the touch inputs 235—e.g., the malware 220 can receive information regarding which keys are pressed, where a mouse is clicked on the display 205, and/or receive information regarding touches on the display 205 via a touchscreen interface. In at least one embodiment, a user of system 200 may be unaware of the malware 220—e.g., a user of system 200 may be unable to detect or determine the system 200 is compromised. Additionally, the malware 220 may interfere or otherwise infect the operating system 230 and cause data accessible by the operating system 230 to be corrupt and compromised.

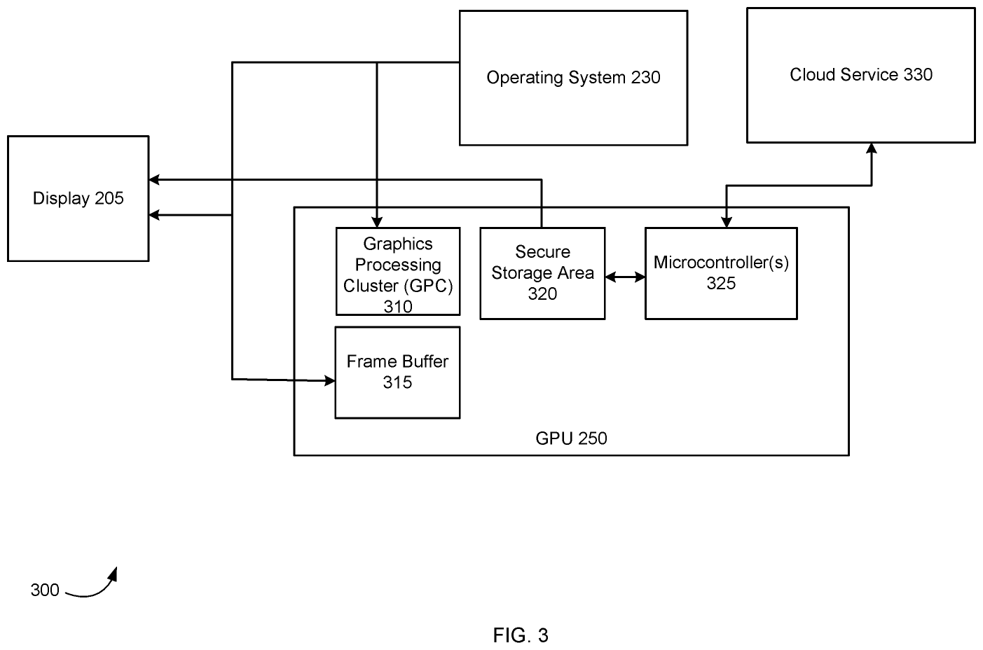

In one embodiment, the GPU 250 can include a second secure storage area that is inaccessible by the operating system as illustrated with reference to FIG. 3. In such embodiments, the GPU 250 can include information that is not corrupted by malware 220—e.g., because the data stored at the second secure storage area is inaccessible by the operating system 230, it would also be inaccessible by the malware 220 infecting the operating system 230. In at least one embodiment, the GPU 250 can include (e.g., or be coupled to) a microcontroller that can access the second secure storage area and cause data stored at the second secure storage area to be presented in the GUI of display 205—e.g., the microcontroller can bypass the driver 225 to display the secure input display 215. In one example, the GPU 250 can store data associated with the secure input display 215 at the second storage area. In some embodiments, the GPU 250 can also communicate directly with a cloud service provider or other application outside the operating system 230 for authentication as described with reference to FIG. 3. That is, an application outside the operating system 230 can communicate directly with the GPU 250, enabling the GPU 250 to display the secure input display 215 for authentication of a user of system 200. Because the second storage area is inaccessible by the operating system 230 and the GPU 250 does not utilize the driver 225 to display the secure input display 215, both the operating system 230 and malware 220 can be unaware of the secure input display 215 presented on the display 205—e.g., both the operating system 230 and malware 220 will see only the background 210.

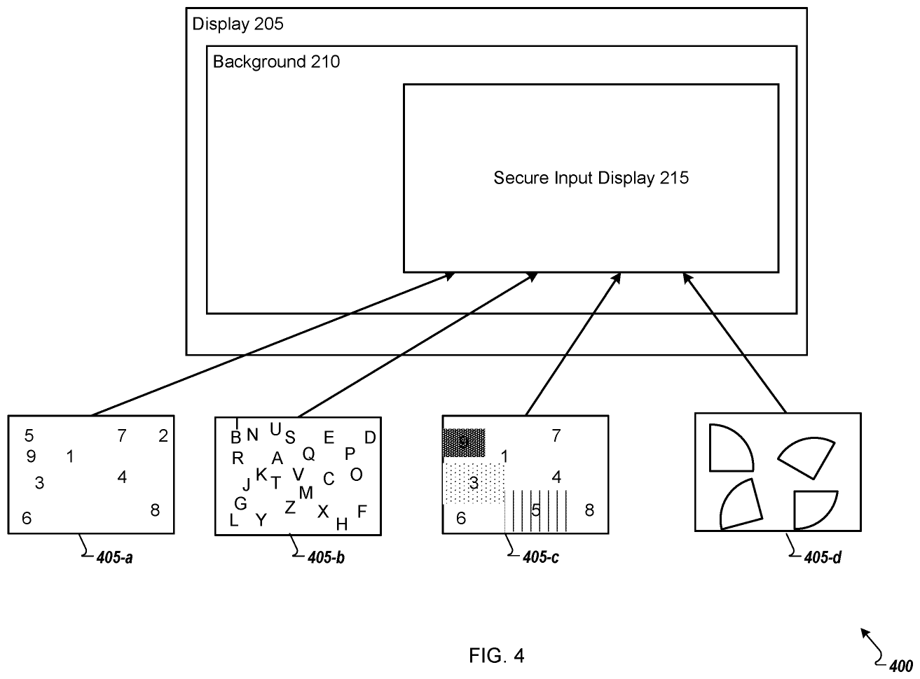

As described with reference to FIG. 4, the secure input display 215 can be presented in a random location (e.g., the GPU 250 can generate random coordinates on the display 205 to present the secure input display 215). Additionally, the secure input display 215 can present random letters, images, shapes, numbers, etc., in random locations within the secure input display 215 for the authentication as described with reference to FIG. 4. The user of system 200 can utilize the touch inputs 235 (e.g., arrow keys of the keyboard, the mouse, or a touchscreen interface) to select the appropriate characters, images, or shapes for authentication within the input display 215. Accordingly, even if malware 220 is utilizing a screen grabber and a keylogger, the malware 220 will be unable to access or determine the information within the secure input display 215. That is, as a user of system 200 moves their mouse, touches the screen, or utilizes the arrow keys, the malware 220 will be unable to determine what information is being selected—e.g., the malware 220 may be able to determine the mouse moved and clicked something, or that the user selected the arrow keys, but because the malware 220 cannot see the secure input display 215 and the secure input display 215 is presented in random locations, the malware 220 is unable to detect or obtain the information selected by the user. Accordingly, even if the system 200 is compromised, the user can still be authenticated for applications not associated with the operating system 230 via the secure input display 215 presented directly by the GPU 250 (e.g., the secure input display 215 bypasses the operating system 230 to remain uncompromised). It should be noted that because the system 200 can be compromised without a user's knowledge, all or most of authentications of applications outside the operating system 230 can be handled by the GPU 250—e.g., the secure input display 215 can be utilized at all or most of the times, even when the system is not compromised.

FIG. 3 illustrates an example system 300 for preventing capture of input from keyboard and display using keyloggers and screen grabbers, according to at least one embodiment. In some embodiments, system 300 can include the display 205, operating system 230, and graphics processing unit (GPU) (e.g., a graphics card) as described with reference to FIG. 2. In one embodiment, the system 300 can also include a cloud service 330. In one embodiment, the GPU 250 can include a graphics processing cluster (GPC) 310, a frame buffer 315, a secure storage area 320, and a microcontroller 325.

In at least one embodiment, the GPC 310 is a dedicated hardware block that can perform computations, rasterization, shading, and texturing—e.g., the GPC 310 can perform most of a GPU's core graphics functions. In at least one embodiment, frame buffer 315 is a portion of memory (e.g., random-access memory (RAM)) that stores a bitmap and drivers a video display—e.g., the frame buffer 315 can store data representing pixels in a video frame, a frame rate, or other information associated with a display of the system. In one embodiment, the GPC 310 and frame buffer 315 are accessible by the operating system 230—e.g., a graphics driver (e.g., driver 225 as described with reference to FIG. 2) can convert the data stored at the GPC 310 and frame buffer 315 into graphics, images, text, videos, etc. for display on the display 205.

In one embodiment, the GPU 250 can include one or more microcontrollers 325. In some embodiments, the microcontrollers 325 can perform video encryption and video decryption, set up memory within the GPU 250, access data to be displayed on display 205, and/or generate protected content. For example, one microcontroller 325 can be responsible for encrypted data that cannot be accessed by the operating system 230—e.g., one microcontroller 325 can access the secure storage area 320 that is inaccessible by the operating system 230. In at least one embodiment, the microcontrollers 325 can include firmware signed and authenticated by a manufacturer of the GPU 250—e.g., the microcontrollers 325 will utilize firmware that is digitally signed and therefore avoid utilizing corrupted firmware or be affected by any potential malware (e.g., malware 220 as described with reference to FIG. 2).

In at least one embodiment, the GPU 250 (e.g., or the graphics card that includes GPU 250) can be an authenticator—e.g., the GPU 250 or the graphics card can utilize an authentication protocol to authenticate requests from a cloud service 330. For example, the GPU 250 can be a fast identity online (FIDO) authenticator. In other embodiments, the GPU 250 can utilize an application programming interface (API) to perform the authentication—e.g., the GPU 250 can utilize Windows Hello API. In either example, the GPU 250 can include a microcontroller 325 or other hardware that communicates with the cloud service 330 for the authentication. In one embodiment, the cloud service 330 can be an application and infrastructure resource that exists on the internet. In some embodiments, the cloud service 330 can request a user of system 300 to be authenticated before providing protected content. As described with reference to FIG. 2, the operating system 230 can be compromised due to malware (e.g., malware 220 as described with reference to FIG. 2). Accordingly, the cloud service 330 can request the authentication via the graphics card or GPU 250 and bypass the operating system 230 entirely. For example, the cloud service 330 can establish a connection with the graphics card or GPU 250 via the FIDO authentication or respective API. In such examples, the cloud service 330 can request a password for the authentication. In at least one embodiment, a microcontroller 325 of the GPU 250 can access the secure storage area 320 after receiving the authentication request from the cloud service 330. In other examples, a second device can request the authentication in lieu of the cloud service—e.g., a second device connected to the system 300 such as a USB flash drive or other device that can be authenticated before it is accessible.

In some embodiments, the secure storage area 320 can store data associated with the secure input display 215 as described with reference to FIG. 2. For example, the secure storage area 320 can store data associated with numbers, characters, letters, images, shapes, captchas, etc., that can be used for authentication. In such embodiments, the microcontroller 325 can access the secure storage area 320 to read data associated with the authentication request from the cloud service 330—e.g., read data depending on the type of authentication requested by the cloud service 330 as described with reference to FIG. 4. For example, the cloud service 330 can request a password for authentication and the microcontroller 325 can access the secure storage area 320 for the relevant numbers, letters, or special characters that may possibly be used for the password authentication.

In at least one embodiment, the GPU 250 (e.g., the microcontroller 325) can cause the data stored in the secure storage area 320 to be displayed on the display 205 as the secure input display 215—e.g., the system 300 can utilize a driver not associated with the operating system 230 or one or more microcontrollers to facilitate displaying the data stored in the secure storage area 320 in the secure input display 215. In at least one embodiment, the microcontroller 325 can ensure the secure input display 215 is presented randomly on the display 205—e.g., the microcontroller 325 can generate random coordinates for the secure input display 215 as well as randomly generate positions for the data displayed inside the secure input display 215 as described with reference to FIG. 4. In at least one embodiment, the information transmitted from the GPU 250 to the display 205 can be protected or encrypted such that the operating system 230 is unaware of the contents—e.g., the GPU 250 can encrypt the data to be displayed on the secure input display 215 so that the operating system 230 cannot read or otherwise access the data. In some embodiments, the data received from the user via the secure input display 215 can also be encrypted so the operating system 230 is unaware of the selections made by the user of system 300—e.g., the password or other input entered by the user is encrypted so the operating system 230 is unaware. After receiving the information from the secure input display 215, the GPU 250 can send the information to the cloud service 330 for authentication—e.g., the cloud service 330 can determine whether the information received is correct. In some embodiments, the cloud service 330 can determine the information received is correct and authenticate the user of system 300 to use the cloud service 330. In other embodiments, the cloud service 330 can determine the information received is incorrect and not provide access to the user.

It should be noted the GPU 250 or graphics card can directly display the secure input display 215 via a high-definition multimedia interface (HDMI) or video graphics array (VGA) interface—e.g., the GPU 250 can bypass the operating system using either the HDMI or VGA interface.

FIG. 4 illustrates a system 400 illustrating a sample secure input display 215 for preventing capture of input from keyboard and display using keyloggers and screen grabbers, according to at least one embodiment. System 400 can include display 205, background 210, and secure input display 215 as described with reference to FIGS. 2 and 3.

In one embodiment, FIG. 4 illustrates possible graphical user interfaces (GUIs) presented within the secure input display 215 during an authentication process as described with reference to FIGS. 2-3. As described with reference to FIGS. 2 and 3, the secure input display 215 can be presented in any random location on the display 205. For example, a graphics card or graphics processing unit (GPU) can determine a random position for the secure input display 215 to overlay a display presented by an operating system (e.g., operating system 230 as described with reference to FIG. 2). That is, the secure input display 215 can be any size, shape, and be presented in any location on the display 205. It should be noted that the secure input display 215 can be presented in a different location each time—e.g., because the secure input display 215 is presented in random locations, the location of the secure input display 215 can change each time. Additionally, the secure input display 215 is not visible to the operating system 230 or any malware 220 present in the system.

In one embodiment, the secure input display 215 can display numbers as illustrated at 405-a. In at least one embodiment, the numbers can be randomly positioned within the secure input display 215—e.g., the graphics card or GPU 250 can also randomly generate positions for each letter, number, character, shape, captcha, etc. displayed within the secure input display 215. It should be noted that although the numbers 1-9 are displayed at 405-a, the secure input display can present any quantity of numbers as needed for authentication by a cloud service (e.g., cloud service 330 as described with reference to FIG. 2). A user of system 400 can select the numbers via touch inputs 230 as described with reference to FIG. 2—e.g., the user can select the numbers using the arrow keys (e.g., cursor movement keys), a mouse, or via touchscreen interface. As the secure input display 215 is not visible to the operating system and randomly positioned on the display 205 and the numbers within the secure input display 215 are randomly positioned as well, an unauthorized user is unable to determine what information the user of system 400 is selecting. For example, the user could click the numbers “1,” “2,” “3,” “4,” and “5.” In such embodiments, the unauthorized user is only able to see five clicks taking place on the background 210—e.g., the unauthorized user is unable to see the secure input display 215 or the numbers within 405-a. Additionally, as the secure input display 215 also positions the numbers randomly, even if the unauthorized user tracked where exactly the user clicked, it will fail reveal any information of the user—e.g., the numbers will be presented in a different manner at a second time the authentication takes place and the clicks would be in different locations rendering the unauthorized user's tracking of the clicks useless.

Similar to the numbers presented at 405-a, the secure input display 215 could also present letters as illustrated at 405-b. In some embodiments, the secure input display 215 can present lowercase and uppercase letters. In other embodiments, the secure input display 215 can present numbers having different backgrounds as illustrated at 405-c. In such embodiments, the authentication can be a set of instructions telling the user to select numbers with a dotted background, shaded background, etc. In some embodiments, the numbers or letters presented in secure input display 215 can have different colors and the authentication instructions could indicate to the user to select all or most of the red numbers or all or most of the black numbers. In another embodiment, the secure input display 215 can present shapes as illustrated at 405-d. In such embodiments, the user can be instructed to make a shape (e.g., make a circle), or select pieces of the shape in a particular manner (e.g., select portions of the circle starting with a respective portion and then proceed to select the next portion in clockwise direction). Although not illustrated, the secure input display 215 could also present special characters (e.g., !, @, #, $, etc.), captchas, or any combination thereof (e.g., any combination of numbers, letters, special characters, shapes, captchas, etc.). That is, the secure input display 215 can present any type of authentication as required by a cloud service. By presenting them in the secure input display 215, a user of system 400 can securely enter the information for authentication even if the system is compromised by malware.

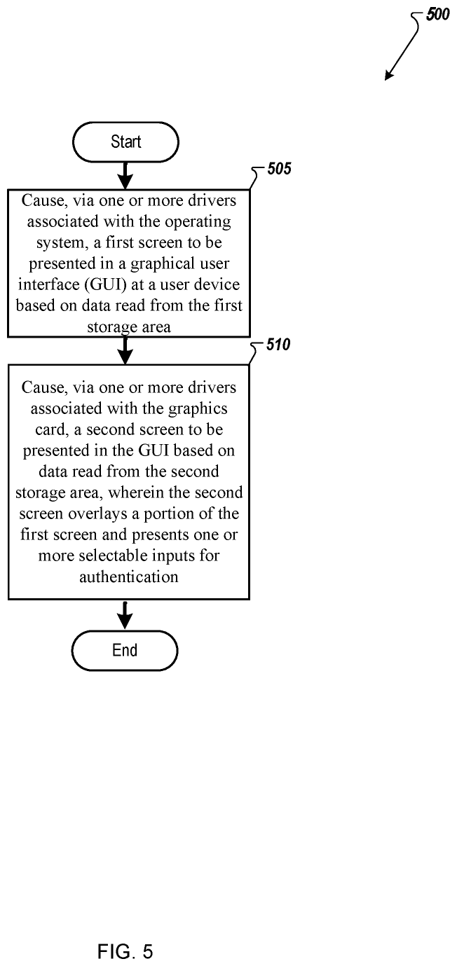

FIG. 5 illustrates a flow diagram of a method 500 for preventing capture of input from keyboard and display using keyloggers and screengrabbers, according to at least one embodiment. The method 500 can be performed by processing logic comprising hardware, software, firmware, or any combination thereof. In at least one embodiment, the method 500 is performed by system 200, 300, or 400 as described with reference to FIGS. 2-4. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other diagrams illustrating a method for preventing capture of input from keyboard and display using keyloggers and screengrabbers, are possible.

At operation 505, processing logic causes, via one or more drivers associated with an operating system (e.g., operating system 230 as described with reference to FIG. 2), a first screen to be presented in a graphical user interface (GUI) at a user device based on data read from a first storage area. That is, the processing logic can, via the drivers 225 as described with reference to FIG. 2, cause the background 210 to be presented on the display 205. In some embodiments, the first storage area can refer to the graphics processing cluster (GPC) 310 or the frame buffer 315 described with reference to FIG. 3. In some embodiments, the first storage area can be located on a graphics card or GPU 250 as described with reference to FIGS. 2 and 3. In at least one embodiment, the first storage area is accessible the operating system.

At operation 510, processing logic causes, via one or more drivers associated with the graphics card, a second screen to be presented in the GUI based on data read from the second storage area, wherein the second screen overlays at least a portion of the first screen and presents one or more selectable inputs for authentication. That is, the processing logic can, via microcontrollers 325 or other drivers associated with the graphics card, cause the secure input display 215 described with reference to FIG. 2 to be presented on the display 205. In at least one embodiment, the second storage area is an example of the secure storage area 320 and is inaccessible by the operating system. In at least one embodiment, the second screen is also inaccessible by the operating system—e.g., the second screen is invisible to the operating system. In at least one embodiment, the processing logic, via the one or more drivers associated with the graphic card, generates a random position for the second screen to be presented in the GUI—e.g., the secure input display 215 can be randomly positioned anywhere within the display 205 each time an authentication process occurs. In at least one embodiment, the selectable inputs are one of characters, numbers, alphanumeric characters, alphabet letters, words, symbols, images, puzzle elements, captchas, etc., as described with reference to FIG. 4. In such embodiments, the selectable inputs can be selected via cursor movement keys, a cursor (from a mouse), or a touch via touchscreen interface of the GUI. In at least one embodiment, the processing logic, via the one or more drivers associated with the graphics card, can generate random positions within the second screen for each selectable input of the one or more selectable inputs—e.g., the processing logic can randomly arrange the numbers, letters, symbols, words, shapes, captchas within the secure input display 215 as described with reference to FIG. 4. In some embodiments, the processing logic can also display a set of instructions along with the selectable inputs within the second screen—e.g., instructions specifying the manner of authentication. For example, the processing logic can cause a display of instructions that indicate to select all or most of red numbers, complete a circle in a clockwise direction, select all or most of images with a bike, etc.

In at least one embodiment, the processing logic can receive, at the graphics card, an authentication request for an application or a device (e.g., receive an authentication request from the cloud service 330 as described with reference to FIG. 3), where the data is read from the second storage area responsive to receiving the authentication request as described with reference to FIG. 3. In at least one embodiment, the processing logic can receive, via the GUI at the user device, one or more inputs—e.g., the processing logic can receive information from the user corresponding to the selection of inputs by the user at the GUI via the touch inputs 235. In some embodiments, the processing logic can compare the received one or more inputs with a stored value—e.g., a stored authentication value. In other embodiments, the processing logic can transmit the one or more inputs to a second device or cloud service to enable the second device or cloud service to authenticate the received inputs.

In one embodiment, the processing logic can determine that the one or more inputs satisfy the stored value—e.g., satisfy the correct stored password, pin, or authentication information. In at least one embodiment, the processing logic can authenticate the one or more inputs responsive to determining the one or more inputs satisfy the stored value. In such examples, the processing logic can encrypt the one or more inputs and output the encrypted one or more inputs to the application or second device—e.g., to the cloud service or the second device. In some embodiments, the processing logic can determine that the one or more inputs fail to satisfy the stored value and refrain from authenticating the one or more inputs accordingly. In other embodiments, the processing logic can receive an indication from the application or second device that one or more inputs are correct and authenticated. In at least one embodiment, the processing logic can receive an indication from the application or second device that the one or more inputs are incorrect and failed to authenticate.

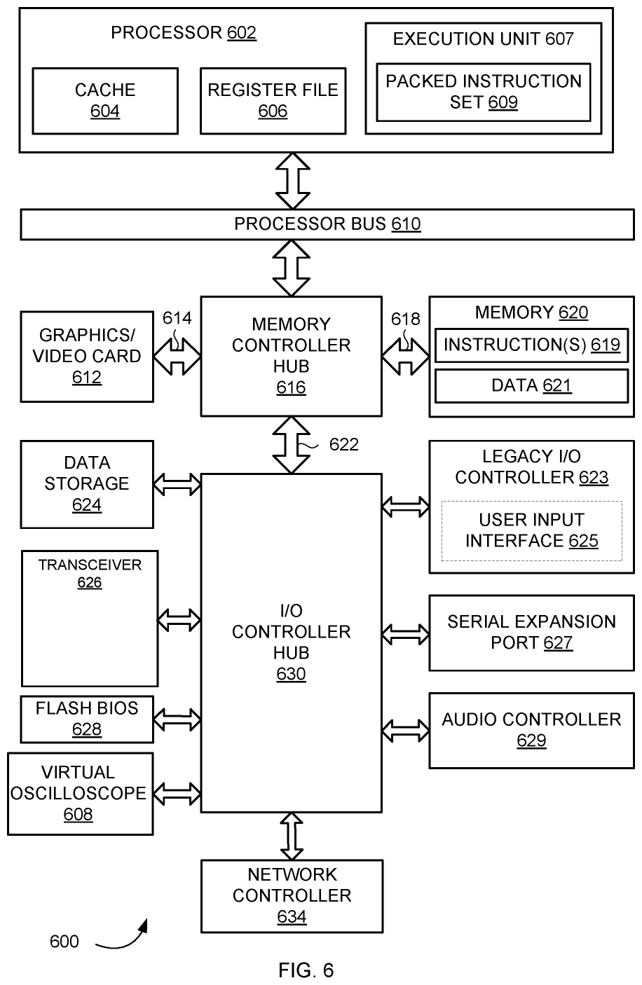

FIG. 6 illustrates a computer system 600 in accordance with at least one embodiment. In at least one embodiment, computer system 600 may be a system with interconnected devices and components, an SOC, or some combination. In at least one embodiment, computer system 600 is formed with a processor 602 that may include execution units to execute an instruction. In at least one embodiment, computer system 600 may include, without limitation, a component, such as processor 602 to employ execution units including logic to perform algorithms for processing data. In at least one embodiment, computer system 600 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 600 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 600 may be used in devices such as graphics processing units (GPUs), network adapters, central processing units and network devices such as switch (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 600 may include, without limitation, processor 602 that may include, without limitation, one or more execution units 607 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 600 is a single processor desktop or server system. In at least one embodiment, computer system 600 may be a multiprocessor system. In at least one embodiment, processor 602 may include, without limitation, a CISC microprocessor, a RISC microprocessor, a VLIW microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. In at least one embodiment, processor 602 may also include a combination of both internal and external caches. In at least one embodiment, a register file 606 may store different types of data in various registers including, without limitation, integer registers, floating point registers, status registers, and instruction pointer register.

In at least one embodiment, execution unit 607, including, without limitation, logic to perform integer and floating point operations, also resides in processor 602. Processor 602 may also include a microcode (“ucode”) read only memory (“ROM”) that stores microcode for certain macro instructions. In at least one embodiment, processor 602 may include logic to handle a packed instruction set 609. In at least one embodiment, by including packed instruction set 609 in an instruction set of a general-purpose processor 602, along with associated circuitry to execute instructions, operations used by many multimedia applications may be performed using packed data in a general-purpose processor 602. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, an execution unit may also be used in microcontrollers, embedded processors, graphics devices, DSPs, and other types of logic circuits. In at least one embodiment, computer system 600 may include, without limitation, a memory 620. In at least one embodiment, memory 620 may be implemented as a DRAM device, an SRAM device, flash memory device, or other memory device. Memory 620 may store instruction(s) 619 and/or data 621 represented by data signals that may be executed by processor 602.

In at least one embodiment, a system logic chip may be coupled to processor bus 610 and memory 620. In at least one embodiment, the system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data and textures. In at least one embodiment, MCH 616 may direct data signals between processor 602, memory 620, and other components in computer system 600 and to bridge data signals between processor bus 610, memory 620, and a system I/O 622. In at least one embodiment, system logic chip may provide a graphics port for coupling to a graphics controller. In at least one embodiment, MCH 616 may be coupled to memory 620 through high bandwidth memory path 618 and graphics/video card 612 may be coupled to MCH 616 through an Accelerated Graphics Port (“AGP”) interconnect 614.

In at least one embodiment, computer system 600 may use system I/O 622 that is a proprietary hub interface bus to couple MCH 616 to I/O controller hub (“ICH”) 630. In at least one embodiment, ICH 630 may provide direct connections to some I/O devices via a local I/O bus. In at least one embodiment, local I/O bus may include, without limitation, a high-speed I/O bus for connecting peripherals to memory 620, a chipset, and processor 602. Examples may include, without limitation, an audio controller 629, a firmware hub (“flash BIOS”) 628, a transceiver 626, a data storage 624, a legacy I/O controller 623 containing a user input interface 625 and a keyboard interface, a serial expansion port 627, such as a USB, and a network controller 634. Data storage 624 may comprise a hard disk drive, a floppy disk drive, a CD-ROM device, a flash memory device, or other mass storage device. In an embodiment, the transceiver 626 includes a constrained FFE 608.

In at least one embodiment, FIG. 6 illustrates a system, which includes interconnected hardware devices or “chips” in a transceiver 626—e.g., the transceiver 626 includes a chip-to-chip interconnect including a first device and a second device. In at least one embodiment, FIG. 6 may illustrate an exemplary SoC. In at least one embodiment, devices illustrated in FIG. 6 may be interconnected with proprietary interconnects, standardized interconnects (e.g., PCIe), or some combination thereof and utilize a GRS link. In at least one embodiment, one or more components of system 600 are interconnected using compute express link (“CXL”) interconnects. In an embodiment, the memory 620 can include a secure storage area as described with reference to FIGS. 1-4 e.g., the system 600 can include a secure storage area not accessible by an operating system, where the secure storage area stores graphical information associated with a secure display as described with reference to FIGS. 2-5—e.g., the system 600 can display an area for a user to securely enter information without the inputs being accessible by the operating system.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a graphics card comprising a first storage area accessible by an operating system and a second storage area inaccessible by the operating system; and
a processing device, coupled to the graphics card, to perform operations comprising:
cause, via one or more drivers associated with the operating system, a first screen to be presented in a graphical user interface (GUI) at a user device based on data read from the first storage area; and
cause, via one or more drivers associated with the graphics card, a second screen to be presented in the GUI based on data read from the second storage area, wherein the second screen overlays a portion of the first screen and presents one or more selectable inputs for authentication.

2. The system of claim 1, wherein the processing device is to further:
receive, at the graphics card, an authentication request for an application or a device, wherein the data is read from the second storage area responsive to receiving the authentication request.

3. The system of claim 1, wherein the processing device is to further:
receive, via the GUI at the user device, one or more inputs; and
compare the one or more inputs with a stored value.

4. The system of claim 3, wherein the processing device is further to:
determine the one or more inputs satisfy the stored value;
authenticate the one or more inputs responsive to determining the one or more inputs satisfy the stored value;
encrypt the one or more inputs; and
output the encrypted one or more inputs to an application or device.

5. The system of claim 3, wherein the processing device is further to:
determine the one or more inputs fail to satisfy the stored value; and
refrain from authenticating the one or more inputs responsive to determining the one or more inputs fail to satisfy the stored value.

6. The system of claim 1, wherein the processing device is further to:
generate, via the one or more drivers associated with the graphics card, a random position for the second screen to be presented in the GUI.

7. The system of claim 1, wherein the one or more selectable inputs are one of characters, numbers, alphanumeric characters, alphabet letters, words, symbols, images, or puzzle elements.

8. The system of claim 1, wherein the one or more selectable inputs can be selected via cursor movement keys, a cursor, or touch on the GUI.

9. The system of claim 1, wherein the processing device is further to:
generate, via the one more drivers associated with the graphics card, a random position within the second screen for each selectable input of the one or more selectable inputs.

10. A method comprising:
causing, via one or more drivers associated with an operating system, a first screen to be presented in a graphical user interface (GUI) at a user device based on data read from a first storage area at a graphics card, wherein the first storage area is accessible by an operating system; and
causing, via one or more drivers associated with the graphics card, a second screen to be presented in the GUI based on data read data from a second storage area at the graphics card, wherein the second storage area is inaccessible by the operating system, and wherein the second screen overlays a portion of the first screen and presents one or more selectable inputs for authentication.

11. The method of claim 10, further comprising:
receiving, at the graphics card, an authentication request for an application or a device, wherein the data is read from the second storage area responsive to receiving the authentication request.

12. The method of claim 10, further comprising:
receiving, via the GUI at the user device, one or more inputs; and
comparing the one or more inputs with a stored value.

13. The method of claim 12, further comprising:
determining the one or more inputs satisfy the stored value;
authenticating the one or more inputs responsive to determining the one or more inputs satisfy the stored value;
encrypting the one or more inputs; and
outputting the encrypted one or more inputs to an application or device.

14. The method of claim 12, further comprising:
determining the one or more inputs fail to satisfy the stored value; and
refraining from authenticating the one or more inputs responsive to determining the one or more inputs fail to satisfy the stored value.

15. The method of claim 10, further comprising:
generating, via the one or more drivers associated with the graphics card, a random position for the second screen to be presented in the GUI.

16. The method of claim 10, wherein the one or more selectable inputs are one of characters, numbers, alphanumeric characters, alphabet letters, words, symbols, images, or puzzle elements.

17. The method of claim 10, wherein the one or more selectable inputs can be selected via cursor movement keys, a cursor, or touch on the GUI.

18. The method of claim 10, further comprising:
generating, via the one more drivers associated with the graphics card, a random position within the second screen for each selectable input of the one or more selectable inputs.

19. A non-transitory computer-readable medium storing instructions thereon, wherein the instructions, when executed by a processing device, cause the processing device to:
cause, via one or more drivers associated with an operating system, a first screen to be presented in a graphical user interface (GUI) at a user device based on data read from a first storage area at a graphics card, wherein the first storage area is accessible by an operating system; and
cause, via one or more drivers associated with the graphics card, a second screen to be presented in the GUI based on data read data from a second storage area at the graphics card, wherein the second storage area is inaccessible by the operating system, and wherein the second screen overlays a portion of the first screen and presents one or more selectable inputs for authentication.

20. The non-transitory computer-readable medium of claim 19, wherein the processing device is further to:
receive, at the graphics card, an authentication request for an application or a device, wherein the data is read from the second storage area responsive to receiving the authentication.
